(19) United States
(12) Patent Application Publication
(10) Pub. No.: US 2014/0351090 A1
(43) Pub. Date: Nov. 27, 2014

(54) GRAPHICAL USER INTERFACE FOR PRESENTATION OF ITEMS

(71) Applicants: AJ Rana, Santa Clara, CA (US); Roy Eddings, Logan, UT (US)

(72) Inventors: AJ Rana, Santa Clara, CA (US); Roy Eddings, Logan, UT (US)

(73) Assignee: FAZIT.COM, SAN JOSE, CA (US)

(21) Appl. No.: 13/901,229

(22) Filed: May 23, 2013

(51) Int. Cl. G06Q 30/06

(52) U.S. Cl. CPC G06Q 30/0641; G06Q 30/0625
USPC 705/26.62

(57) ABSTRACT

Methods and apparatuses for presenting a user interface for visual search results are described herein. The methods include indexing a plurality of metadata values of each of a plurality of items and generating a plurality of item categories based on the plurality of metadata values, and determining a primary item category and a subordinate item category from the plurality of categories. The methods also include presenting, in a search window, a primary row comprising a first plurality of metadata icons, wherein each of the first plurality of metadata icons is indicative of one of the plurality of metadata values associated with the primary item category, presenting, in the search window, a subordinate row comprising a second plurality of metadata icons, wherein each of the second plurality of metadata icons is indicative of one of the plurality of metadata values associated with the subordinate item category, and presenting, in a results window, the plurality of items associated with the first plurality of metadata icons and the second plurality of metadata icons.

### TECHNICAL FIELD

The embodiments of the disclosure relate generally to computing systems and, more specifically, relate to graphical user interfaces for presenting visual search results.

### BACKGROUND

The percentage of people shopping online continues to increase every year as more and more people become comfortable ordering things from online retailers. These online retailers, in an effort to capture more of the purchases continue to increase their inventory. The population of items available for sale may number in the thousands and hundreds of thousands at some of the larger retailers. Another example of a large population of items is a course offering at a university, or a listing of securities such as stocks, mutual funds, and bonds.

Sifting through such a population of items typically proceeds by initially performing a word search and then selecting a filter to narrow the population of results based on the properties of the items. However, some items, such as a vehicle, may have tens to hundreds of different properties. Combined with the properties of all the available vehicles and the task of searching for the right vehicle can become daunting because the application of each filter requires a new search be performed using the filter.

### SUMMARY OF THE INVENTION

Methods and apparatuses for providing a user interface for visual search results are described herein. The methods include indexing metadata values of items and generating categories based on the metadata values. The methods also include determining a primary item category and a subordinate item category, presenting a primary row of metadata icons, and a subordinate row of metadata icons. Each of the metadata icons is indicative of one of metadata values associated with either the primary or subordinate item category. The methods, in one embodiment include presenting, in a results window, the items associated with the metadata icons.

The methods also includes presenting, in the search window, a multiple subordinate rows, wherein each of the subordinate rows has a priority and metadata icons, and receiving a selection of at least one of the metadata icons and modifying the metadata icons in the subordinate rows that have a lower priority than a priority associated with the selection. In one embodiment, the methods include presenting, in the results window, items associated with the metadata icons in a one of the subordinate rows with a lowest priority, and receiving a selection of multiple metadata icons.

In a further embodiment, the methods include receiving a reordering of the subordinate rows such that one of the subordinate rows becomes a new primary row. Each one of the metadata icons in one row may be indicative of a quantity of the items having metadata associated with the each one of the metadata icons. The apparatuses are provided to implement the methods.

A computing system is provided to implement the above described method. The computing system, in one example, includes a memory, and a processor coupled with the memory. The processor executes an item manager that is configured to perform the above described methods.

In addition, a computer readable storage medium for item presentation is described. An exemplary computer readable storage medium provides instructions, which when executed on a processing system causes the processing system to perform a method such as the methods discussed above.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a network diagram including a computing system that has an item manager.

FIG. 2 is a block diagram illustrating one embodiment of the item manager.

FIG. 3 is a block diagram of one embodiment of a user interface in accordance with embodiments of the disclosure.

FIG. 4 is a flow diagram of one embodiment of a method of dynamically presenting search results.

FIG. 5 illustrates a diagrammatic representation of a machine in the exemplary form of a computing system within which a set of instructions, for causing the machine to perform any one or more of the methodologies described herein, may be executed.

### DETAILED DESCRIPTION

Methods and apparatuses for presenting a user interface for visual search results are described herein. The methods include indexing a plurality of metadata values of each of a plurality of items and generating a plurality of item categories based on the plurality of metadata values, and determining a primary item category and a subordinate item category from the plurality of categories. The methods also include presenting, in a search window, a primary row comprising a first plurality of metadata icons, wherein each of the first plurality of metadata icons is indicative of one of the plurality of metadata values associated with the primary item category, presenting, in the search window, a subordinate row comprising a second plurality of metadata icons, wherein each of the second plurality of metadata icons is indicative of one of the plurality of metadata values associated with the subordinate item category, and presenting, in a results window, the plurality of items associated with the first plurality of metadata icons and the second plurality of metadata icons.

The methods described below beneficially allow a web user to visually search a multitude of items dynamically, without requiring a page refresh between item selections. This is accomplished by presenting a search window adjacent a results window or area. The search window may be arranged in a plurality of rows, where each row contains icons representative of a category of metadata associated with the item. By selecting one of the metadata icons in the row, a user dynamically filters the items in the results window and also metadata icons in rows that have a lower priority than the row with the selected icon.

In the following description, numerous details are set forth. It will be apparent, however, to one of ordinary skill in the art having the benefit of this disclosure, that embodiments of the present invention may be practiced without these specific details.

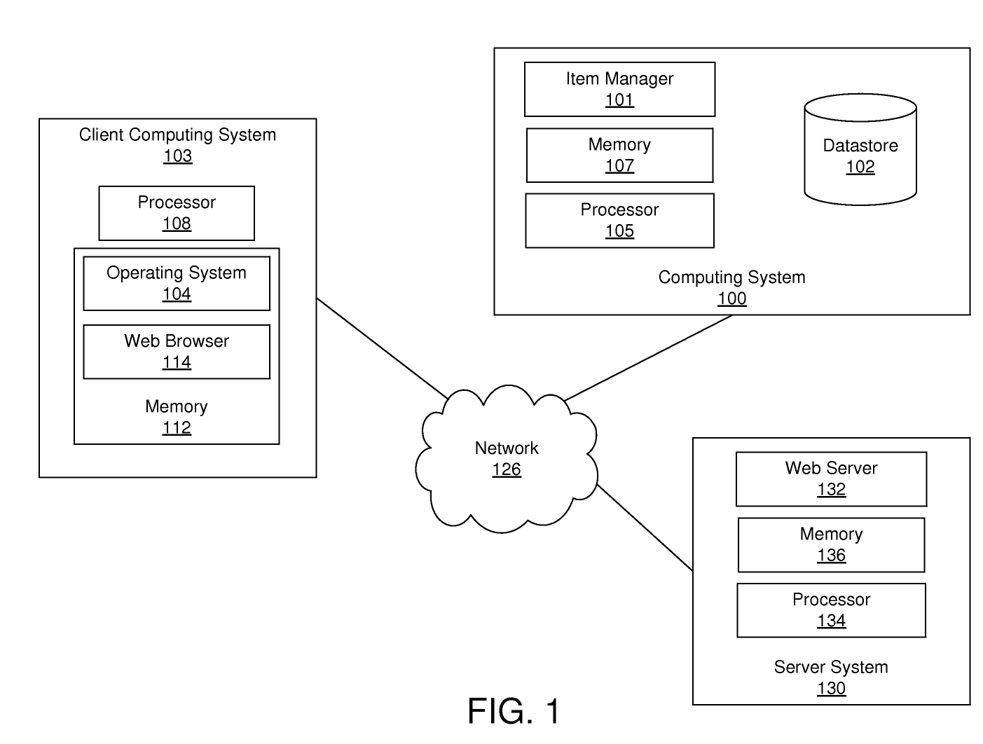

FIG. 1 is a network diagram including a computing system 100 that has an item manager 101. The item manager 101, as described above, processes a plurality of items maintained in a datastore 102 to enable a dynamic visual presentation of search results over a network 126 to a client computing system 103. The client computing system, sometimes called a user device, typically includes a central processing unit (CPU) 108, hereinafter “processor” 108, a memory 112, an operating system 104, and other components (not shown for clarity) to enable the client computing system 103 to communicate over the network 126 with other devices and systems, including, but not limited to, the computing system 100 or other server computing systems (e.g., server 130). Similarly, the computing system 100 also includes a processor 105 and memory 107.

Each of the systems described herein with reference to FIG. 1 may further include standard I/O devices such as a keyboard, a mouse, a printer, and a display device, as well as, other standard input/output (I/O) devices, such as a compact disk (CD) or DVD drive, floppy disk drive, or other digital or waveform port for inputting data to and outputting data from the client computing system 103.

In one embodiment, the client computing system 103 is coupled via a network 126 to one or more other computer systems, such as the server system 130 or computing system 100. The network 126 can be any network or network system that is of interest to a user, including, but not limited to, any local or wide area network. The server system 130 may include a web server 132, a processor 134, a memory 136, and a network interface (not shown).

In one embodiment, the web server 132 serves web pages, applets and information to, and also receives information from, client devices (e.g., client computing system 103) over the network 126. The server 130 may be any server computer may include a machine readable medium (i.e., disk drives, flash memory, etc.) that may be accessed locally or remotely via any communication protocol. The server system 130 may be implemented as a cluster of servers, including a grouping of function specific servers such as database servers, user-interface servers, applications servers, etc. In other words, the web server 132 may serve webpages based on information stored in other server systems such as information stored in the datastore 102 of the computing system 100. The server 130 and the computing system 100 may be clustered together to function as a single server system. In an alternative embodiment, the item manager 101 and the datastore 102 may reside on the same machine as the web server 132.

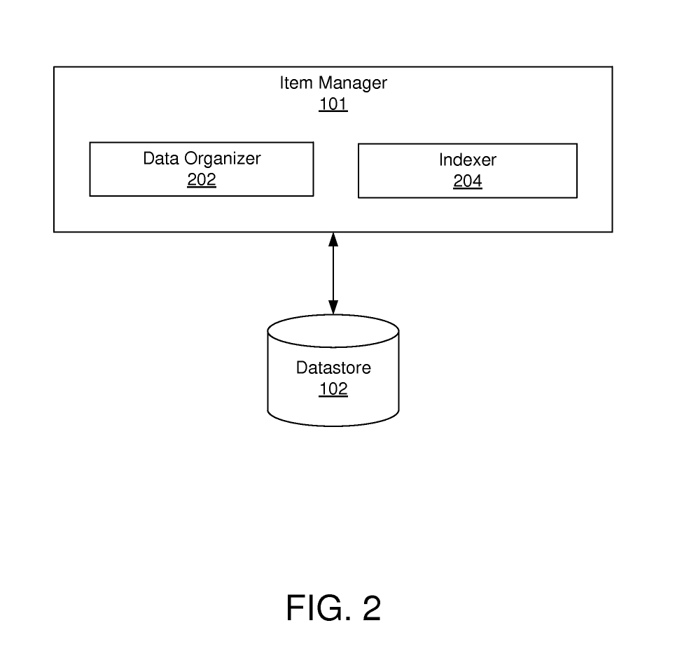

The datastore 102, in one embodiment, is a database configured to store a plurality of items and metadata associated with those items. The plurality of items may represent any item that a user may desire to view, via the web browser 114, for any purpose including, but not limited to, entertainment, shopping, etc. In other words, the datastore 102 may store any type of item that is graphically representable by an icon. Examples of items may include, but are not limited to, vehicles, clothing, household items, other items for sale (e.g., stocks, bonds, insurance products, etc.), other services for sale, etc. The datastore 102 may be a relational database, or in other embodiments, any structured collection of data. The item manager 101 is configured to analyze the items stored in the datastore 102 to generate a plurality of categories based on metadata of the items. This will be described below in greater detail with reference to FIG. 2.

FIG. 2 is a block diagram illustrating one embodiment of the item manager 101. The item manager 101, in the depicted embodiment, includes a data organizer 202, and an indexer 204. The item manager 101 may also include other components common to a computing device including, but not limited to, a log and error manager, cache manager, file manager, etc., which are not shown herein for clarity.

The item manager 101 is configured to analyze items in the datastore 102. Each item in the datastore 102 may include metadata. The metadata describes the item. For example, if the item is representative of a book, the metadata associated with the book may include values that relate to categories such as, but not limited to, author name, year published, subject, language, genre, etc. The indexer 204, based on the analysis of the items, creates the categories based on the metadata values of the items. In another embodiment, the data organizer 202 is configured to intake items from an external source, analyze the items, retrieve metadata values, and input the items with the metadata into the datastore 102, after which the indexer 204 generates the categories. In one embodiment, the metadata values are retrieved from a search engine, input manually, or identified by analyzing the item.

In one embodiment, the indexer 204 creates new metadata values for each item in the datastore 102. For example, the indexer 204, after an analysis of the items, determines that the items in the datastore 102 are vehicles. The indexer 204 is configured to assign to each vehicle metadata values that represent, for example, the year, make, model, etc., of each vehicle. In one example, this analysis may comprise parsing a particular item to extract the metadata values. For instance, if the item is a “2010 Porsche 911 Turbo, 67,000 miles, black,” then the indexer 204 parses the item to extract the make “Porsche,” year “2010,” etc.

The indexer 204 is also configured to recognize items in the datastore 102 that previously have been associated with metadata, whether performed previously by the indexer 204 or some other device, generate categories for the metadata, and determine a category priority. The indexer 204, in this situation, analyzes the different metadata values to first determine a primary category. In one embodiment, the primary category is identified based on the metadata values of the items. For instance, the primary category may be identified as the category with the fewest amount of variations among the metadata values. For example, if a category such as “vehicle type” has only metadata values of “car,” “truck,” and “SUV” (for a total of three different metadata values), while other categories such as “make” or “year” have tens or hundreds of different values across the items in the datastore 102, the “vehicle type” category is identified as the primary category. Alternatively, the primary category may be identified as the category having the greatest amount of variations. In another embodiment, the primary category may be predetermined. In other words, the item manager 101 may be configured to receive input from a user indicative of which category is the primary category.

In a similar manner to the above, the indexer 204 is configured to identify subordinate categories that are related to the primary category. The term “subordinate category” refers to a category that has a determined priority that is less than the primary category. In one embodiment, the priority is a numeric value assigned to a category, which may be in the arbitrarily chosen range of between 1 and 100, for example. If the greatest priority is chosen as 100, and assigned to the primary category, then each subordinate category may have an identified priority of less than 100. The item manager 101 may prioritize, or rank, the categories (e.g., primary and subordinate categories) based on the priorities.

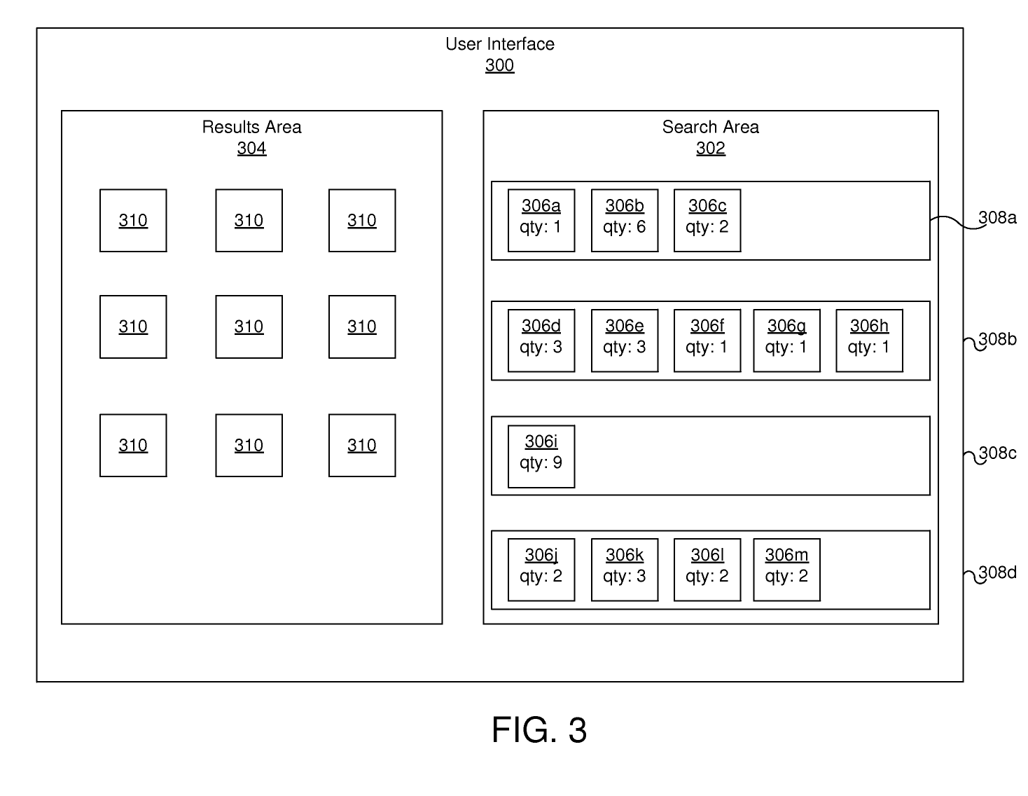

The priority of each subordinate category may be identified according to the criteria described above. In other words, the first subordinate category may be the next category after the primary category that has the next fewest amount of variations among metadata values, or in the alternative, the next greatest amount of variations among metadata values. In this manner, the indexer is configured to generate a hierarchical relationship (i.e., the above described ranking) between categories such that the primary category is presented with a greater prominence than any subordinate category, as will be described in greater detail below with reference to FIG. 3. In another embodiment, the indexer may determine a ranking for each category in the hierarchical relationship using different criteria (e.g., greatest variation, least variation). In an alternative embodiment, the indexer 204 may randomly assign a ranking to each of the categories based on a random number generator, or alternatively, based upon input from a user.

FIG. 3 is a block diagram of one embodiment of a user interface in accordance with embodiments of the disclosure. In the depicted embodiment, the user interface 300 includes a search area 302 and an adjacent results area 304. The item manager 101, of FIGS. 1 and 2, is configured to generate the search area 302, in one embodiment, to present a grouping of metadata icons 306 in a row format as depicted. In another embodiment, the categories may be presented in the user interface 300 as columns. In yet another embodiment, the categories may be presented as a closed curve that encircles a set of metadata values. Each row (collectively referenced as “rows 308,” and individually as “row 308a,” row 308b,” etc.) represents one of the above described categories. In other words, each row 308 presents a grouping of metadata icons 306 that are associated with a particular row 308.

The item manager 101 may be an integrated component of the web server 132 of FIG. 1, or alternatively, the item manager 101 may communicate with the web server 132 a particular arrangement of the search area 302 and the results area 304 to be presented to a user. As described above, the indexer 204 of the item manager 101 determines a priority for each of the categories which are represented in the user interface 300 by the rows 308. The indexer 204 identifies the primary categories and the item manager 101 generates a primary row 308a to present metadata icons 306 associated with the primary category. Each metadata icon 306, in one example, is indicative of a distinct metadata value. As multiple items in the datastore may have a common metadata value, each metadata icon 306a, 306b, etc., may also represent a quantity of items having a particular metadata value. For example, if the items in the datastore are representative of vehicles for sale, the metadata icons 306a, 306b, 306c may be indicative of vehicle types such as “sedan,” “truck,” and “SUV,” respectively. In the depicted embodiment, therefore, the icons indicate that there is one sedan, six trucks, and two SUVs.

The indexer 204, as described above, may determine the primary category, and subsequently the primary row 308a, by identifying the category with the greatest variation of metadata values, or the least variation of metadata values. In the depicted embodiment, the primary row 308a presents three distinct metadata values, which indicate a total of nine associated items.

The item manager 101 is also configured to present, via the user interface, the subordinate rows 308b-d. As depicted, the subordinate rows 308b-d may be presented beneath the primary row 308a. In another embodiment, the rows 308a-d may be arranged in any manner that indicates the hierarchical relationship between the highest priority of the primary row 308a, and the lowest priority of subordinate row 308d. The item manager 101 is configured to modify the presentation of icons based upon a selection of a metadata icon 306. For example, if a selection of metadata icon 306b is received by the item manager 101, the item manager 101 is configured to hide or remove any icon in any lower priority row (i.e., row 308b-d) that is not associated with the six items of metadata icon 306b. For instance, if the user selected the metadata icon 306b representative of “truck,” any metadata icon 306 in any subordinate row 308b-d that is not associated with one of the six trucks is removed.

The item manager 101 is configured to present, in the results area, item icons 310 that are representative of items associated with the metadata icons 306 presented in the search area 302. In one embodiment, the item manager 101 presents in the results area 304 item icons 310 which are associated with the metadata icons 306 presented in the lowest priority row 308. Stated differently, if a selection of a metadata icon (e.g., metadata icon 306c) results in the item manager 101 removing metadata icons 306k, 3061, and 306m from row 308d, the item manager dynamically (i.e., without refreshing the user interface 300), modifies the item icons 310 which are presented in the results area to only present the item icons 310 associated with the remaining metadata icon 306j, which in this example would result in two item icons 310 in the results area.

In one embodiment, the item manager 101 is also configured to receive multiple selections per row 308 (i.e., multiple selections per category). For example, the item manager 101 may be configured to receive a user selection for “truck” 306b and “SUV” 306c. In this example, the item manager 101 is configured to remove from any subordinate row 308b-d any metadata icon that is not associated with the selection. In certain embodiments, the item manager modifies the quantity count of the metadata icons 306 in accordance with the selection. For example, if “truck” is selected in row 308a, the item manager 101 may reduce the quantity of the metadata icon 306e according to the selection. If reducing the quantity results in a “zero” count, the item manager 101 removes the metadata icon 306 from the row 308b. In a similar manner, the item manager 101 is configured to receive selections for any of the presented rows and modify the presented metadata icons 306 in the subordinate rows (i.e., rows 308 with lower priorities. In another embodiment, the item manager is configured to receive a selection in a subordinate row 308b-d and modify the metadata icons 306 in any row with a higher priority including the primary row 308a.

In a further embodiment, the item manager 101 is configured to receive a re-prioritization of rows 308 from a user. In one example, the item manager 101 is configured to detect input from a user that is indicative of a reordering of rows 308. For example, the item manager 101 may detect that the user has “dragged” row 308c to the primary row position adjacent the row 308a. Other examples of re-prioritizing the rows 308 may include, but are not limited to, receiving from a user a new priority value, etc.

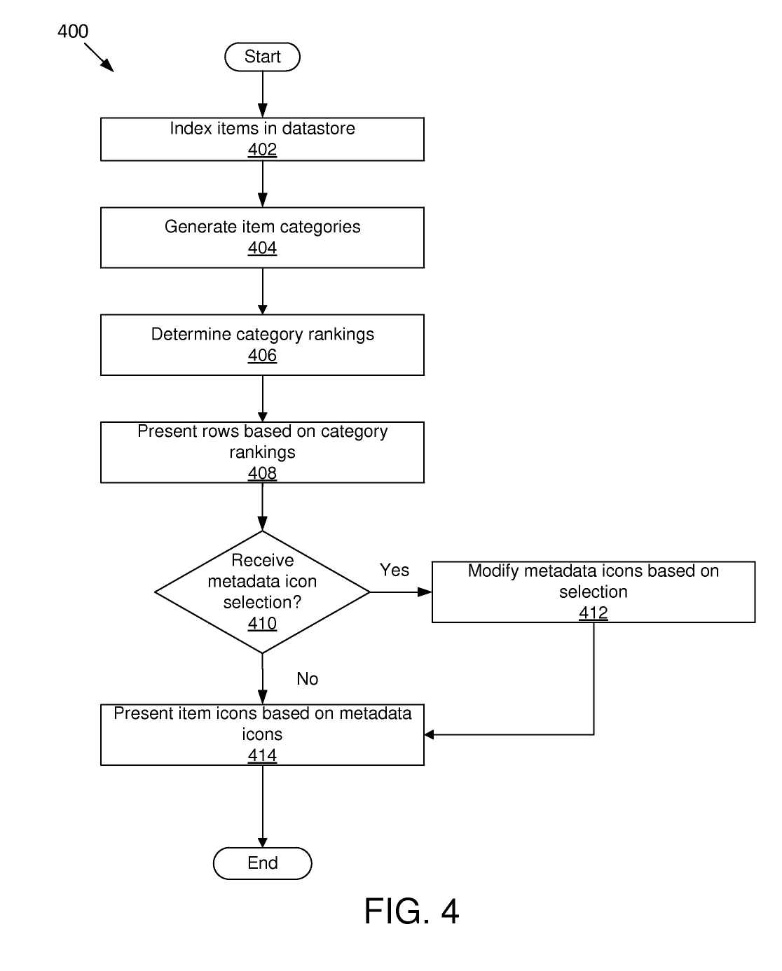

FIG. 4 is a flow diagram of one embodiment of a method 400 of dynamically presenting search results. The method 400 is performed by processing logic that may comprise hardware (circuitry, dedicated logic, etc.), software (such as is run on a general-purpose computing system or a dedicated machine), or a combination of both. In one embodiment, the item manager 101 performs the method 300. Alternatively, other components of the server system 100 perform some or all of the method 400.

Referring to FIG. 4, processing logic begins method 400 by indexing, at block 402, items stored in the datastore of FIG. 1. In one embodiment, the processing logic indexes the items by analyzing the metadata values associated with each item and identifying how many different metadata values exist across the different items. The processing logic then, at block 404, generates item categories based on the metadata values. In one example, the processing logic generates item categories by analyzing the metadata values to find similarities. In another embodiment, the processing logic retrieves categories for an item from an external database, search engine, etc. In a further embodiment, the processing logic may receive item categories from a user.

In block 406, the processing logic determines category rankings based on the metadata values. In one embodiment, the processing logic determines category rankings by identifying how many different metadata values exist in one category, and the quantity of items associated with each of the different metadata values. The category with the greatest number of metadata values may be assigned the highest, or alternatively, the lowest ranking In another embodiment, the processing logic determines the category rankings by receiving an indication from a user that a particular category is the primary category, etc.

At block 408, the processing logic presents rows based on the category rankings. In one embodiment, the category with the highest priority ranking is assigned by the processing logic to be the primary row. Subsequent rows are ordered, by the processing logic, according to the priority ranking. In a further embodiment, and as described above, the processing logic may receive an indication from a user that the rows should be re-prioritized, at which point the processing logic recalculates the priority ranking of the rows based on the user input. For example, if the user drags the bottom, or lowest priority row, to the top position (see FIG. 3), then the processing logic is configured to calculate a new priority ranking for each of the rows based on the new primary row.

At block 410, the processing logic determines if a metadata icon selection has been made. If yes, the processing logic, at block 412, modifies the presentation of metadata icons based on the selection. In one embodiment, the processing logic removes metadata icons from lower priority rows (i.e., rows beneath the row with the selection) that are not associated with the metadata icon selection. In a further embodiment, the processing logic reduces the quantity count presented with the metadata icon based on the selection, and if the count reduces to zero, the processing logic removes the metadata icon. If no metadata icon selection is received, the processing logic does not modify the metadata icons.

At block 414, the processing logic presents items in the results area based on the metadata icons in the search area. In one embodiment, the processing logic presents item icons according to the metadata icons present in the row with the lowest priority ranking. In the embodiment of FIG. 3, the row with the lowest priority ranking is the row 308d. A selection of a metadata icon in any of the rows will result in the processing logic modifying the metadata icons present in any subordinate row. Accordingly, the processing logic modifies the item icons present in the results area. The method 400 then ends.

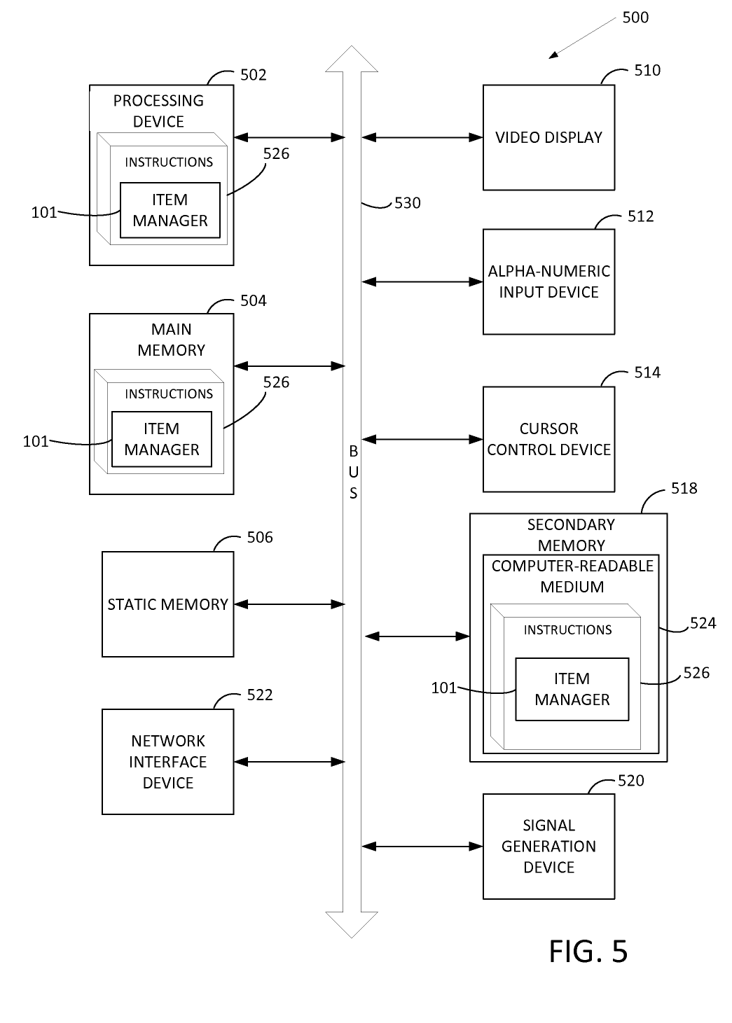

FIG. 5 illustrates a diagrammatic representation of a machine in the exemplary form of a computing system 500 within which a set of instructions, for causing the machine to perform any one or more of the methodologies discussed herein, may be executed. Within the computer system 500 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system Error! Reference source not found.00 includes a processing device Error! Reference source not found.02, a main memory Error! Reference source not found.04 (e.g., read-only memory (ROM), flash memory, dynamic random access memory (DRAM) such as synchronous DRAM (SDRAM) or DRAM (RDRAM), etc.), a static memory Error! Reference source not found.06 (e.g., flash memory, static random access memory (SRAM), etc.), and a secondary memory Error! Reference source not found.18 (e.g., a data storage device in the form of a drive unit, which may include fixed or removable computer-readable storage medium), which communicate with each other via a bus Error! Reference source not found.30.

Processing device Error! Reference source not found.02 represents one or more general-purpose processing devices such as a microprocessor, central processing unit, or the like. More particularly, the processing device Error! Reference source not found.02 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device Error! Reference source not found.02 may also be one or more special-purpose processing devices such as an application specific integrated circuit (ASIC), a field programmable gate array (FPGA), a digital signal processor (DSP), network processor, or the like. Processing device Error! Reference source not found.02 is configured to execute the instructions Error! Reference source not found.26 for performing the operations and steps discussed herein.

The computer system Error! Reference source not found.00 may further include a network interface device Error! Reference source not found.22. The computer system Error! Reference source not found.00 also may include a video display unit Error! Reference source not found.10 (e.g., a liquid crystal display (LCD) or a cathode ray tube (CRT)) connected to the computer system through a graphics port and graphics chipset, an alphanumeric input device Error! Reference source not found.12 (e.g., a keyboard), a cursor control device Error! Reference source not found.14 (e.g., a mouse), and a signal generation device Error! Reference source not found.20 (e.g., a speaker).

The secondary memory Error! Reference source not found.18 may include a machine-readable storage medium (or more specifically a computer-readable storage medium) Error! Reference source not found.24 on which is stored one or more sets of instructions Error! Reference source not found.26 embodying any one or more of the methodologies or functions described herein. In one embodiment, the instructions Error! Reference source not found.26 include instructions for the item manager 101 as described herein. The instructions Error! Reference source not found.26 may also reside, completely or at least partially, within the main memory Error! Reference source not found.04 and/or within the processing device Error! Reference source not found.02 during execution thereof by the computer system Error! Reference source not found.00, the main memory Error! Reference source not found.04 and the processing device Error! Reference source not found.02 also constituting machine-readable storage media.

The computer-readable storage medium Error! Reference source not found.24 may also be used to store the instructions Error! Reference source not found.26 persistently. While the computer-readable storage medium Error! Reference source not found.24 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions Error! Reference source not found.26, components and other features described herein can be implemented as discrete hardware components or integrated in the functionality of hardware components such as ASICS, FPGAs, DSPs or similar devices. In addition, the instructions Error! Reference source not found.26 can be implemented as firmware or functional circuitry within hardware devices. Further, the instructions Error! Reference source not found.26 can be implemented in any combination hardware devices and software components.

In the above description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “monitoring,” “identifying,” “generating,” “providing,” “selecting,” “obtaining,” “receiving,” “deleting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth above are merely exemplary. Particular implementations may vary from these exemplary details and still be contemplated to be within the scope of the present invention.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
indexing, by a processor, a plurality of metadata values of each of a plurality of items and generating a plurality of item categories based on the plurality of metadata values;
determining a primary item category and a subordinate item category from the plurality of categories;
presenting, in a search window, a primary row comprising a first plurality of metadata icons, wherein each of the first plurality of metadata icons is indicative of one of the plurality of metadata values associated with the primary item category;
presenting, in the search window, a subordinate row comprising a second plurality of metadata icons, wherein each of the second plurality of metadata icons is indicative of one of the plurality of metadata values associated with the subordinate item category; and
presenting, in a results window, the plurality of items associated with the first plurality of metadata icons and the second plurality of metadata icons.

2. The method of claim 1, further comprising presenting, in the search window, a plurality of subordinate rows, wherein each of the plurality of subordinate rows has a priority and a plurality of metadata icons.

3. The method of claim 2, further comprising receiving a selection of at least one of the metadata icons of the pluralities of metadata icons and modifying the plurality of metadata icons in the plurality of subordinate rows that have a lower priority than a priority associated with the selection.

4. The method of claim 3, further comprising presenting, in the results window, the plurality of items associated with the plurality of metadata icons in one of the plurality of subordinate rows with a lowest priority.

5. The method of claim 3, further comprising receiving a selection of multiple metadata icons of the pluralities of metadata icons.

6. The method of claim 2, further comprising receiving a reordering of the plurality of subordinate rows such that one of the plurality of subordinate rows becomes a new primary TOW.

7. The method of claim 1, wherein each one of the plurality of metadata icons in one row of the plurality of rows is indicative of a quantity of the plurality of items having metadata associated with the each one of the plurality of metadata icons.

8. A computing system, comprising:
a memory; and
a processor coupled with the memory, the processor to execute an item manager,
wherein the item manager is to:
index a plurality of metadata values of each of a plurality of items and generate a plurality of item categories based on the plurality of metadata values;
determine a primary item category and a subordinate item category from the plurality of categories;
present, in a search window, a primary row comprising a first plurality of metadata icons, wherein each of the first plurality of metadata icons is indicative of one of the plurality of metadata values associated with the primary item category;
present, in the search window, a subordinate row comprising a second plurality of metadata icons, wherein each of the second plurality of metadata icons is indicative of one of the plurality of metadata values associated with the subordinate item category; and
present, in a results window, the plurality of items associated with the first plurality of metadata icons and the second plurality of metadata icons.

9. The computing system of claim 8, wherein the item manager further presents, in the search window, a plurality of subordinate rows, wherein each of the plurality of subordinate rows has a priority and a plurality of metadata icons.

10. The computing system of claim 9, wherein the item manager further receives a selection of at least one of the metadata icons of the pluralities of metadata icons and modifies the plurality of metadata icons in the plurality of subordinate rows that have a lower priority than a priority associated with the selection.

11. The computing system of claim 10, wherein the item manager further presents, in the results window, the plurality of items associated with the plurality of metadata icons in a one of the plurality of subordinate rows with a lowest priority.

12. The computing system of claim 9, wherein the item manager further receives a selection of multiple metadata icons of the pluralities of metadata icons.

13. The computing system of claim 9, wherein the item manager further receives a reordering of the plurality of subordinate rows such that one of the plurality of subordinate rows becomes a new primary row.

14. The computing system of claim 8, wherein each one of the plurality of metadata icons in one row of the plurality of rows is indicative of a quantity of the plurality of items having metadata associated with the each one of the plurality of metadata icons.

15. A non-transitory computer readable storage medium including instructions that, when executed by a processor, cause the processor to perform a method comprising:
indexing, by a processor, a plurality of metadata values of each of a plurality of items and generating a plurality of item categories based on the plurality of metadata values;
determining a primary item category and a subordinate item category from the plurality of categories;
presenting, in a search window, a primary row comprising a first plurality of metadata icons, wherein each of the first plurality of metadata icons is indicative of one of the plurality of metadata values associated with the primary item category;
presenting, in the search window, a subordinate row comprising a second plurality of metadata icons, wherein each of the second plurality of metadata icons is indicative of one of the plurality of metadata values associated with the subordinate item category; and
presenting, in a results window, the plurality of items associated with the first plurality of metadata icons and the second plurality of metadata icons.

16. The non-transitory computer readable storage medium of claim 15, wherein the method further comprises presenting, in the search window, a plurality of subordinate rows, wherein each of the plurality of subordinate rows has a priority and a plurality of metadata icons.

17. The non-transitory computer readable storage medium of claim 16, wherein the method further comprises receiving a selection of at least one of the metadata icons of the pluralities of metadata icons and modifying the plurality of metadata icons in the plurality of subordinate rows that have a lower priority than a priority associated with the selection.

18. The non-transitory computer readable storage medium of claim 17, wherein the method further comprises presenting, in the results window, the plurality of items associated with the plurality of metadata icons in a one of the plurality of subordinate rows with a lowest priority.

19. The non-transitory computer readable storage medium of claim 17, wherein the method further comprises receiving a selection of multiple metadata icons of the pluralities of metadata icons.

20. The non-transitory computer readable storage medium of claim 16, wherein the method further comprises receiving a reordering of the plurality of subordinate rows such that one of the plurality of subordinate rows becomes a new primary row.
